(19) United States
(12) Patent Application Publication
(10) Pub. No.: US 2006/0217052 A1
(43) Pub. Date: Sep. 28, 2006

(54) Coin handling apparatus

(76) Inventors: Kristoffer Barnekow, Malmo (SE); Hakan Melin, Akarp (SE); Kristian Bengtsson, Biarred (SE); Ame Skoog, Skurup (SE); Olov Hagerfors, Akarp (SE)

Correspondence Address: WOMBLE CARLYLE SANDRIDGE & RICE, PLLC, ATTN: PATENT DOCKETING 32ND FLOOR, P.O. BOX 7037, ATLANTA, GA, 30357-0037, US

(21) Appl. No.: 11/347,921

(22) Filed: Feb. 6, 2006

Related U.S. Application Data
(60) Provisional application No. 60/651,669, filed on Feb. 10, 2005.

(30) Foreign Application Priority Data
Feb. 8, 2005 (SE) 0500288-6

(51) Int. Cl. G07D 3/00

(52) U.S. Cl. 453/3

(57) ABSTRACT

It is presented a coin handling apparatus comprising a coin deposit device, a coin router and a plurality of coin containers, wherein the coin router is configured to receive coins from the coin deposit device and to selectively direct coins to any one of the coin containers.

### CROSS-REFERENCE TO RELATED APPLICATIONS

This application claims the benefit of Swedish patent application no. 0500288-6, filed on Feb. 8, 2005 and U.S. provisional patent application No. 60/651,669, filed on Feb. 10, 2005.

### INCORPORATION BY REFERENCE

The specifications of Swedish patent application no. 0500288-6, filed on Feb. 8, 2005 and U.S. provisional patent application No. 60/651,669, filed on Feb. 10, 2005 are incorporated herein in their entirety, by this reference.

### FIELD OF THE INVENTION

The present invention relates generally to a coin handling apparatus and specifically to an apparatus routing coins to a plurality of coin containers.

### TECHNICAL BACKGROUND

A number of different types of coin handling apparatuses are known in the art. Examples thereof are coin sorters, coin counters, vending machines, gambling machines, machines for testing the quality of coins, machines for identifying counterfeit or foreign coins, etc.

It is desirable to provide such an apparatus with capability to handle a very large number of coins. However, removal of coins from such an apparatus can be physically challenging due to the sheer weight of the coins.

### SUMMARY OF THE INVENTION

An object of the present invention is hence to overcome a problem of how to avoid unnecessary risks of injury when handling coin containers.

The object is achieved by a coin handling apparatus comprising a coin deposit device, a coin router and a plurality of coin containers, wherein the coin router is configured to receive coins from the coin deposit device and to selectively direct coins to any one of the coin containers. This allows multiple coin containers to be used, reducing the maximum weight of each container compared to a case where only one container exists. With the reduced weight of each container, these are easier and safer to handle for operators.

The coin router may comprise a coin pipe comprising a top opening and a bottom opening. Using a pipe is a simple and ingenious solution to allow efficient direction of the coins.

The coin router may comprise a motor configured to receive rotation control signals from a control unit for rotating the coin pipe such that the bottom opening of the coin pipe corresponds to a top opening of any one of the coin containers. With such an arrangement, the routing is controlled by the control unit in the apparatus, allowing the routing to be changed when a container is full, as determined by the control unit.

The coin pipe may have a shape similar to the letter s. The coin pipe may be arranged such that an inclination of the coin pipe is relatively higher by the top opening of the coin pipe and the bottom opening of the coin pipe, and the inclination of the coin pipe is relatively lower by a middle section of the coin pipe. It has been proven that an S shape is beneficial, providing lateral movement in the middle section of the coin pipe, while reducing unwanted lateral movement of coins upon entering and exiting the coin pipe.

The coin router may comprise a position sensor configured to provide a position sensor signal to a control unit for determining the rotational position of the coin pipe.

The coin handling apparatus may further comprise a planar member arranged between the bottom opening of the coin pipe and the coin containers, the planar member is configured with a plurality of holes for allowing passage of coins from the coin pipe to the containers. The planar member may be a disc. The planar member allows coins to be accumulated in the coin pipe while coin pipe output is moved from one coin container to another. This in effect creates a buffer, allowing coins to be continued to be provided to the coin pipe while its output is moved.

The planar member may comprise one hole for each coin container.

The coin handling apparatus may comprise a gasket arranged by the bottom opening of the coin pipe. The gasket reduces a risk of coins escaping from the coin pipe out onto the planar member while its output is being moved.

There may be a buffer full sensor arranged by the coin pipe being configured to send a signal to the control unit if a level of coins in the control pipe is over a predetermined threshold level. In this embodiment, the buffer full sensor signals the control unit when the coin pipe is close to getting full, allowing the control unit to stop the flow of coins before an overflow occurs.

There may be a coin jam sensor arranged by the coin pipe, the coin jam sensor being configured to detect a coin jam in the coin pipe. This allows the control unit to stop coin flow if a coin jam occurs, reducing a risk of coin overflow.

The coin handling apparatus may comprise a fill sensor associated with each coin container, the fill sensor being configured to detect a fill level of respective coin container. In this embodiment, the fill sensor signals the control unit when the coin container in question is close to getting full, reducing the need for the control unit itself to keep track the accumulated number or weight of coins for each container.

In one embodiment, the coin handling apparatus may further comprise a plurality of coin guides, wherein the coin router is configured to receive coins from the coin deposit device and configured to selectively direct coins to any one of the coin guides and wherein each coin guide is configured to guide coins received from the coin router to a respective coin container.

As a limit on how many coins a coin handling apparatus can handle is the weight of a container, the multiple containers allows a larger total weight capacity of the machine due to it being possible to handle each container separately.

The coin router may comprise a hollow cylinder, an upper end with an opening for receiving coins from the coin deposit device, and a sloping bottom surface with an opening for providing coins to the coin guides.

Such a coin router provides a robust way for the coins to be directed by the coin router.

In another embodiment of the present invention, the coin guides are coin chutes comprising a top opening and a bottom opening.

In yet another embodiment of the present invention, the coin router comprises a motor configured to receive rotation control signals from a control unit for rotating the coin router such that the opening in the bottom surface in the coin router corresponds to the top opening of any one of the coin chutes. Preferably the control unit is arranged in the coin deposit device, although it is possible to provide the control by use of an externally connected control unit such as a personal computer.

With such an arrangement, the routing is controlled by the processor in the apparatus, allowing the routing to be changed when a container is full, as determined by the processor. The processor can determine that a container is full based on a certain number of coins or the weight of the coins, easily computed accumulating the weight of each detected coin passed to the coin router.

In yet another preferred embodiment of the present invention, the coin router comprises a sensor configured to provide a sensor signal to the control unit for determining the rotational position of the coin router.

The sensor allows the processor to control the position of the router even finer, aligning the coin router bottom opening with the coin guides.

In yet another embodiment, the control unit forms part of said coin deposit device.

In yet another embodiment, the control unit is an external computer.

In yet another preferred embodiment of the present invention, the coin containers are coin bags.

Other objects and aspects of the present invention will become apparent to those skilled in the art after reading this entire specification. It should be understood that both the foregoing general description and the following detailed description are exemplary and explanatory only and are not restrictive of the invention as claimed.

### BRIEF DESCRIPTION OF THE DRAWINGS

The present invention will be more apparent from the accompanying drawings, provided as non-limiting examples, where:

FIG. 1 shows a block diagram of a coin handling apparatus according to the present invention,

FIG. 2 shows an illustrative perspective view of some components of a coin handling apparatus in an embodiment of the present invention,

FIG. 3 is a perspective view of a coin handling apparatus of an embodiment of the present invention, such as the apparatus shown in FIG. 1.

FIG. 4 shows a perspective view of a coin router and a coin guide assembly in a coin handling apparatus of an embodiment of the present invention.

FIG. 5 shows a perspective view of a coin guide assembly in a coin handling apparatus in an embodiment of the present invention.

### DETAILED DESCRIPTION OF EMBODIMENTS

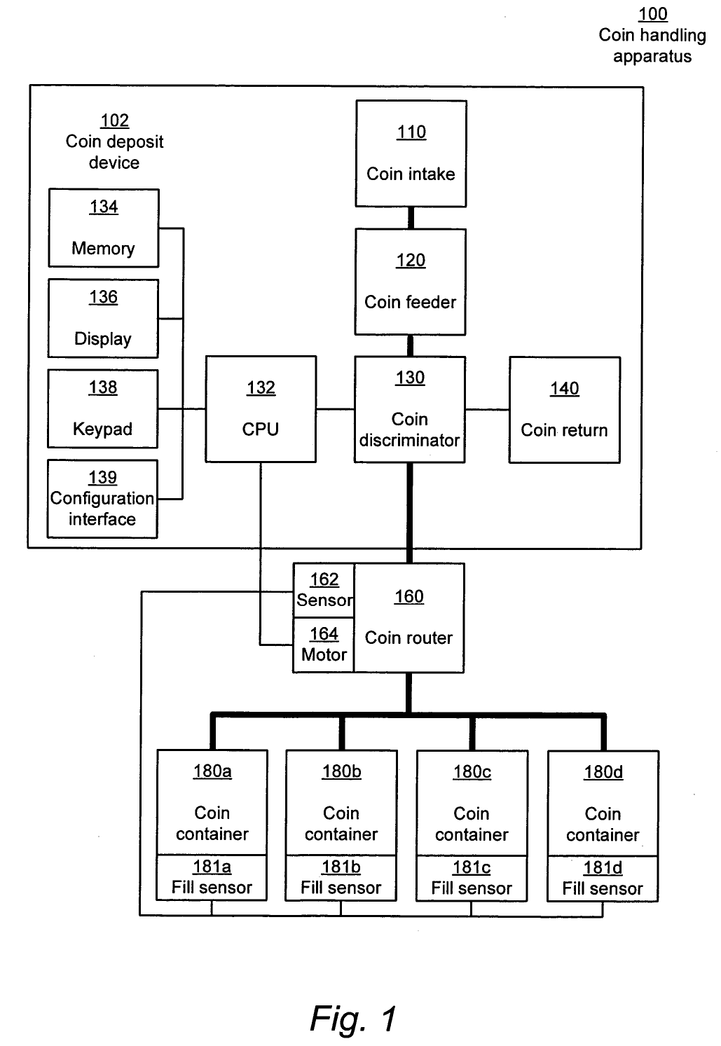

The general structure of a coin handling apparatus 100 according to the present invention is shown in FIG. 1. A coin deposit device 102 provides its coin output to a coin router 160, which provides the coins to a coin guide assembly 170 which guides the coins to any of coin containers 180a, 180b, 180c or 180d.

In the following, blocks 110, 120, 130, 132, 134, 136, 138, 139 and 140 will collectively be referred to as a coin deposit device 102.

Going into more detail regarding the coin deposit device 102, coins are deposited in a coin intake 110. The coins are transported via a coin feeder 120, for example a hopper-type coin feeding device or a conveyor belt, to a coin discriminator 130. The coin discriminator 130 is operatively connected to a control unit 132 in the form of a microprocessor (CPU) or the like, which in turn is operatively connected to a memory 134, such as a RAM, ROM, EEPROM, flash memory, hard disk, or any combination thereof. At least parts of the memory 134 can be implemented by internal memory in the control unit. The control unit 132 is in charge of the overall mode of operation of the apparatus 100, including controlling a display 136 and a key pad 138, which form a user interface. The configuration data relating to the apparatus which the device is intended to update is stored in the memory 134. A configuration interface 139 allows new or modified configuration data to be received by the control unit 132 to be stored in the memory 134. Preferably the control unit is arranged in the coin deposit device, although it is possible to provide the control by use of an externally connected control unit such as an external control computer.

Discriminator 130 identifies any invalid items, such as foreign coins or tokens, and is configured to direct these items to a coin return 140.

The coin return unit 140 preferably returns non-accepted coins through an external opening in the machine 100. It is the coin discriminator 130 that, in this context, determines if a coin is to be accepted or not by detecting different physical parameters, which are used to determine the type, denomination, currency, identity, authenticity or the like of the coin. Examples of physical parameters are conductivity, permeability, thickness, diameter or weight.

The accepted coins are then provided by the coin deposit device 102 to coin router 160. Router 160 comprises a sensor 162 and a motor 164, both connected to control unit 132 or, alternatively, to an external control computer. The signals provided by sensor 162 allows control unit 132 or, alternatively, an external control computer, to determine the rotational position of the router 160, which may result in signals being sent from the control unit 132 or, alternatively, to an external control computer, to the motor 164 for adjusting the position of the router 160 to direct coins to one of four coin containers 180. Some embodiments of the invention may comprise a coin guide assembly (not shown) arranged to guide coins between the coin router 160 and the coin containers 180, as will be described in more detail below. Although four containers, 180a, 180b, 180c and 180d are shown, it is to be noted that any number of containers is consistent with present invention. The coin containers may be of any type, such as coin bags or metal containers. Optionally, fill sensors 181a-d can be provided by respective coin container 180a-d if the coin deposit device 102 is not aware of the number of coins provided to the coin router 160.

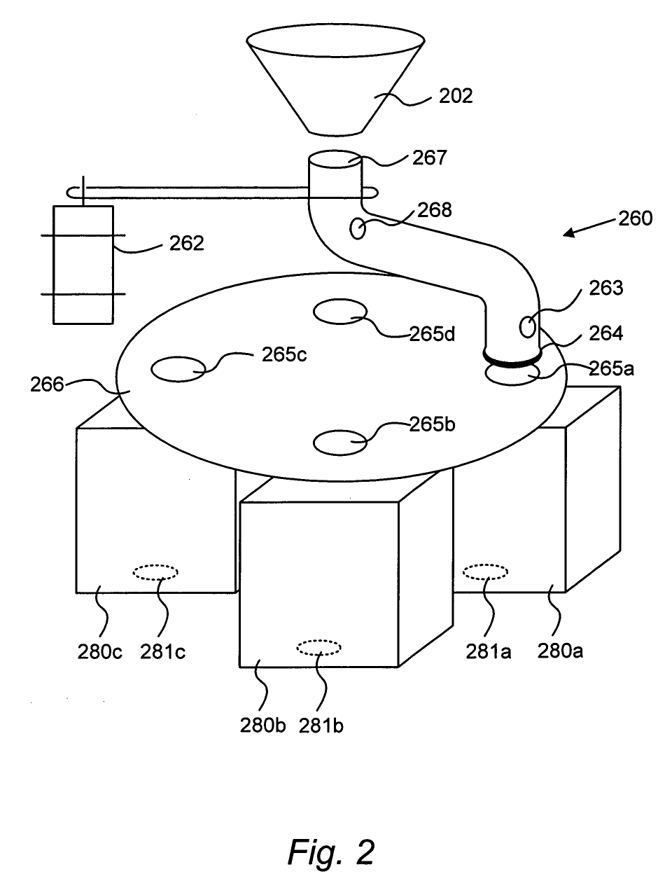

FIG. 2 shows an illustrative perspective view of some components of a coin handling apparatus in an embodiment of the present invention. Note that in FIG. 2, for clarity, the casing of the coin router 260 is not shown; instead some components of the coin router 260 can be seen. In operation, coins are deposited in the coin deposit device 202 and fall by way of gravity into a coin pipe 261, which is part of the coin router 260. The upper opening 267 of the coin pipe 261 is configured such that it is always aligned with the output of the coin deposit device 202 in order to receive coins. A motor 262 is configured to, on instruction from the control unit or external computer (not shown), rotate the coin pipe so that the bottom opening (not shown) is adjusted to one of the coin containers 280a-c. A positional sensor can be mounted by the coin pipe 261 or by motor, sending a signal to the control unit about the rotational position of the coin pipe 261. Note that a fourth container also exists but is not shown in this view. The motor 261 is also part of the coin router 260. With this design, when coins fall into the coin pipe 261, the coin pipe 261 directs the coins to a particular coin bag. In one embodiment, the coin pipe 261 has a coin jam sensor 263, which detects stationary coins stuck in the coin pipe 261. Accordingly, if a coin jam occurs, it is detected by the coin jam sensor and a signal is sent to the controller. The coin jam sensor may for example be an inductive sensor. It is to be noted that although a fully closed pipe is illustrated to be the coin pipe 261, the coin pipe 261 may have any suitable shape allowing coins to be directed from the coin deposit device 202 to the coin containers. For example, the coin pipe 261 may have any open or closed cross-section, the cross section being square, elliptical, circular, u-shaped, etc. In this embodiment, the coin pipe 261 is of a S-shape, where lateral movement is provided in the middle section of the coin pipe 261, while reducing lateral movement upon entering and exiting the coin pipe 261.

In one embodiment, a disc 266 is arranged in the coin router 260, between the bottom of the coin pipe 261 and the coin containers 280a-c. Openings 265a-d in the disc 266 are placed above the coin containers 280-c, to allow coins to pass from the coin pipe 261 to the coin containers 280a-c below. However, between holes, the disc 266 stops coins from falling out of the coin pipe 261. Note that in FIG. 2, the end of the coin pipe 261 appears to be situated somewhat above the disc 266, but this is only for clarity of this illustration. Preferably, the bottom of the coin pipe 261 is very close to, or even touching the disc 266, to prevent coins to fall out onto the disc 266. A gasket 264 may be fitted on the bottom of the coin pipe 261 to allow rotational movement of the coin pipe 261 while still providing a snug fit with the disc. Optionally, the gasket may be loosely fitted between the coin pipe 261 and the disc 266, allowing vertical movement of the coin pipe 261, With the disc in place, coins may continue to be supplied from the coin deposit device 202 to the top of the coin pipe 261 even when the coin pipe 261 needs to be rotated from a full coin container to an empty one. The coin pipe 261 acts as a buffer when the bottom of the coin pipe 261 is covered by the disc during the rotational movement, and when the bottom is aligned with a new whole for an empty coin container, the buffered coins fall into the empty coin container. Optionally, a buffer full sensor 268 can be mounted on the upper part of the coin pipe 261, allowing a signal to be sent to the control unit or the external computer if the level of coins in the coin pipe is above a threshold level, whereby the control unit or external computer can stop the flow of coins into the coin router 260 to prevent overflow of coins. In one embodiment, there is one sensor that is capable of performing the function of both the buffer sensor and the coin jam sensor.

Optionally, fill sensors 281a-c can be provided in respective coin container 280a-c if the coin deposit device 202 is not aware of the number of coins provided to the coin router 260. The fill sensors are connected to the control unit or external computer, and provide a fill level signal representing the fill level to the control unit of external computer. By means of this fill level signal, the control unit or external computer can determine when a coin container is sufficiently filled and, accordingly, directs the coin router 260 to a new, unfilled coin container.

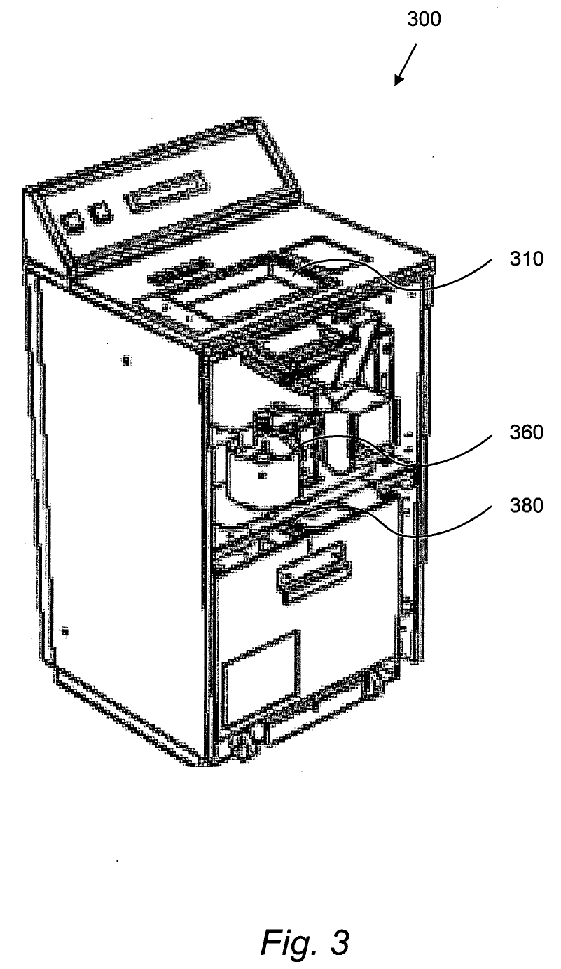

FIG. 3 is a perspective view of a coin handling apparatus of an embodiment of the present invention, such as the apparatus shown in FIG. 1. While only a coin intake 310, a coin router 360 and coin containers 380 are visible from the perspective of the figure, the apparatus comprises elements corresponding to all of the elements illustrated in FIG. 1.

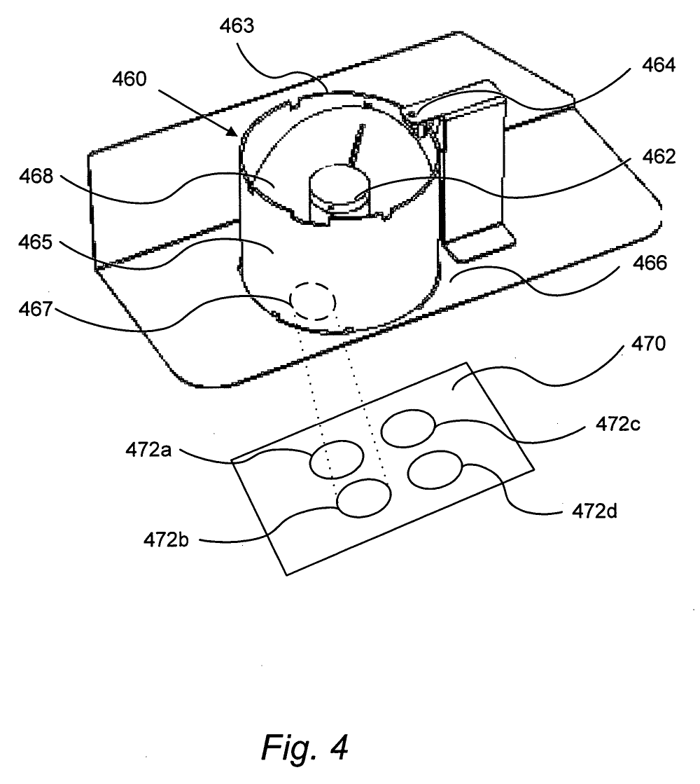

FIG. 4 shows a perspective view of a coin router 460 and a coin guide assembly 470 in a coin handling apparatus of an embodiment of the present invention. The main part of the coin router 460 comprises a cylinder 465 with an upper end opening 463, a motor 462 and a sloped bottom surface 468. The bottom surface 468 is provided with a bottom opening 467. A sensor 464 can detect the rotational position of the coin router 460. A mounting plate 466 is provided for mounting the coin router 460 in a coin handling apparatus. Also shown is coin guide assembly 470 with upper coin guide openings 472a to 472d. In FIG. 4, the coin guide assembly 470 is shown in a position relative to the coin router 460 that is significantly more separated than in an operational situation. In operation the coin guide assembly 470 and the coin router 460 are located close together.

In operation, the coins are provided from a coin deposit device (not shown) to the coin router 460 through the upper end opening 463. Due to the slope of bottom surface 468 the coins fall down to the bottom opening 467 which is positioned so that the coins fall into one of the upper coin guide openings 472a to 472d. The sensor 464 communicates the rotational position to the control unit or external computer (not shown), which is also connected to the motor 462. In this way the control unit, or external computer, can rotationally position the coin router 460 to any one of a number of predetermined positions, where each position makes the bottom opening of the coin router 460 align with one of upper coin guide openings 472a to d, allowing coins to be routed to respective coin guide.

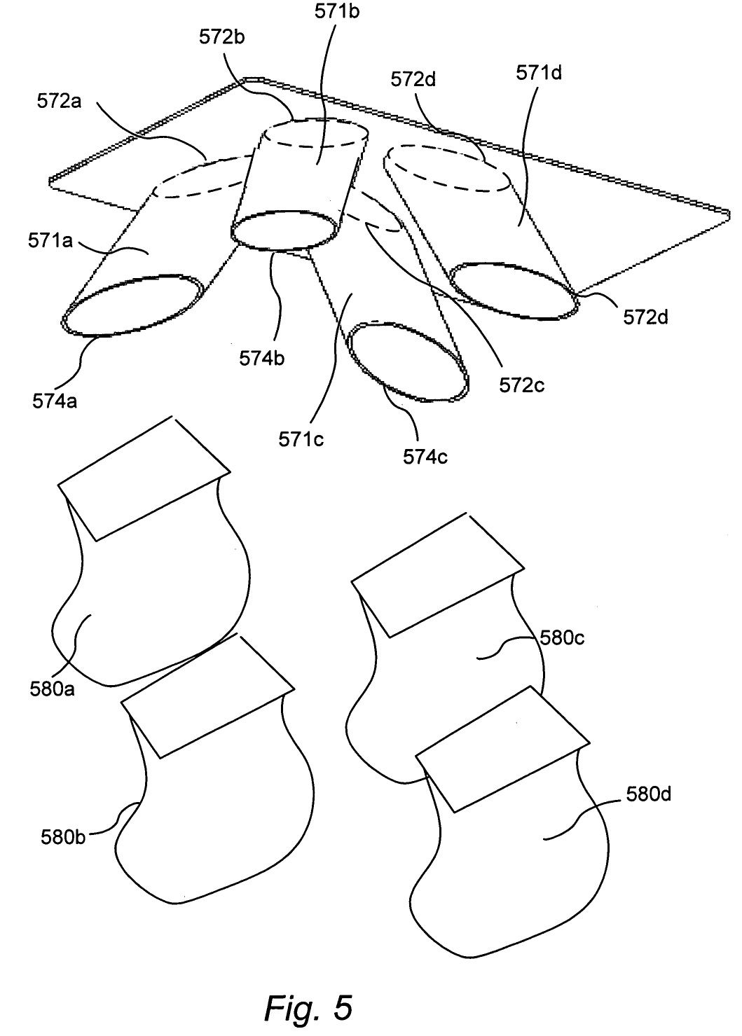

FIG. 5 shows a perspective view of a coin guide assembly 570 in a coin handling apparatus in an embodiment of the present invention. Coins are provided to one of the coin guides 571a to 571d as described above. Which one of these guides 571a to 571d that receive the coins depend on the position of the coin router (not shown), where one of the upper coin guide openings 572a-572d correspond to the bottom opening of the coin router. The coins fall through the coin guide in question to respective bottom coin guide opening 574a to 574d. Each bottom coin guide opening is so positioned that when the coins that fall out of the bottom coin guide opening, they fall into the respective coin container 580a to 580d. In this preferred embodiment of the present invention, the coin containers 580a to 580d are coin bags.

What is claimed is:

1. A coin handling apparatus comprising a coin deposit device, a coin router and a plurality of coin containers, wherein said coin router is configured to receive coins from said coin deposit device and to selectively direct coins to any one of said coin containers.

2. The coin handling apparatus according to claim 1, wherein said coin router comprises a coin pipe comprising a top opening and a bottom opening.

3. The coin handling apparatus according to claim 2, wherein said coin router comprises a motor configured to receive rotation control signals from a control unit for rotating said coin pipe such that said bottom opening of said coin pipe corresponds to a top opening of any one of said coin containers.

4. The coin handling apparatus according to claim 2, wherein said coin pipe has a shape similar to the letter s.

5. The coin handling apparatus according to claim 4, wherein said coin pipe is arranged such that an inclination of said coin pipe is relatively higher by said top opening of said coin pipe and said bottom opening of said coin pipe and the inclination of said coin pipe is relatively lower by a middle section of said coin pipe.

6. The coin handling apparatus according to claim 2, wherein said coin router comprises a position sensor configured to provide a position sensor signal to a control unit for determining the rotational position of said coin pipe.

7. The coin handling apparatus according to claim 2, wherein said coin handling apparatus further comprises a planar member arranged between said bottom opening of said coin pipe and said coin containers, said planar member comprising at least one hole.

8. The coin handling apparatus according to claim 7, wherein said planar member is a disc.

9. The coin handling apparatus according to claim 7, wherein said planar member is configured with a plurality of holes for allowing passage of coins from said coin pipe to said containers.

10. The coin handling apparatus according to claim 7, wherein said coin handling apparatus comprises a gasket arranged by said bottom opening of said coin pipe.

11. The coin handling apparatus according to claim 10, wherein said gasket is arranged on said coin pipe.

12. The coin handling apparatus according to claim 2, wherein there is a buffer full sensor arranged by said coin pipe, said buffer full sensor being configured to send a signal to said control unit if a level of coins in said control pipe is over a predetermined threshold level.

13. The coin handling apparatus according to claim 2, wherein there is a coin jam sensor arranged by said coin pipe, said coin jam sensor being configured to detect a coin jam in said coin pipe.

14. The coin handling apparatus according to claim 1, wherein said coin handling apparatus comprises a fill sensor associated with each coin container, said fill sensor being configured to detect a fill level of respective coin container.

15. The coin handling apparatus according to claim 1, further comprising a plurality of coin guides, wherein said coin router is configured to receive coins from said coin deposit device and configured to selectively direct coins to any one of said coin guides and wherein each coin guide is configured to guide coins received from said coin router to a respective coin container.

16. The coin handling apparatus in claim 15, wherein said coin router comprises:
a hollow cylinder,
an upper end with an opening for receiving coins from said coin deposit device, and
a sloping bottom surface with an opening for providing coins to said coin guides.

17. The coin handling apparatus in claim 15, wherein said coin guides are coin chutes comprising a top opening and a bottom opening.

18. The coin handling apparatus in claim 17, wherein said coin router comprises a motor configured to receive rotation control signals from a control unit for rotating said coin router such that said opening in said bottom surface in said coin router corresponds to said top opening of any one of said coin chutes.

19. The coin handling apparatus in claim 18, wherein the control unit forms part of said coin deposit device.

20. The coin handling apparatus in claim 15, wherein said coin router comprises a sensor configured to provide a sensor signal to a control unit for determining the rotational position of said coin router.

21. The coin handling apparatus in claim 15, wherein the control unit forms part of said coin deposit device.

22. The coin handling apparatus in claim 15, wherein the control unit is an external computer.

23. The coin handling apparatus in claim 15, wherein said coin containers are coin bags.
